(19) United States
(12) Patent Application Publication
(10) Pub. No.: US 2018/0218331 A1
(43) Pub. Date: Aug. 2, 2018

(54) SYSTEM FOR CLOSED-ACCESS MICROCOMMUNITIES

(71) Applicants: Monica Kumar, Los Gatos, CA (US); Ajay Chawla, Troy, MI (US)

(72) Inventors: Monica Kumar, Los Gatos, CA (US); Ajay Chawla, Troy, MI (US)

(21) Appl. No.: 15/747,565

(22) PCT Filed: Jul. 29, 2016
(86) PCT No.: PCT/US16/44651

§ 371 Date: Jan. 25, 2018

Related U.S. Application Data
(60) Provisional application No. 62/198,244, filed on Jul. 29, 2015.

(51) Int. Cl. G06Q 10/10; G06Q 50/00; H04L 12/58

(52) U.S. Cl. CPC G06Q 10/1053; H04L 51/32; G06Q 50/01

(57) ABSTRACT

A system includes at least one processor configured to provide a plurality of closed-access network micro-communities associated with a corresponding plurality of institutions. Each micro-community and corresponding institution may have an associated access list. The processor may display on user devices a user interface portal which is confined to the selected micro-community. The processor may receive via the user interface portal user data from the member users, which is instantly visible in the user interface portal to all member users. The processor may also receive via the user interface portal institution data from one or more administrators of the institution associated with the selected micro-community, which is also instantly visible in the user interface portal to all member users. The processor thus provides a secured-access open exchange between the member users and a secured-access feed from the institution to the member users.

### REFERENCE TO RELATED APPLICATIONS

This application claims priority to U.S. Provisional Application No. 62/198,244 filed on Jul. 29, 2015.

### BACKGROUND

Social media has become ubiquitous. On an individual user level in a given social media platform, users may have the ability to form groups or sub-groups and may have limited control of their visibility to others in the platform or groups. Although users may form groups, due to limits in user visibility users have limited ability to identify other users that may be suited for a particular group. Additionally, due to limits in control over user visibility, users in a group are not assured of isolation in the platform from users outside the group, thus risking undesired exposure to users outside the group.

### SUMMARY

An example system according to the present disclosure includes at least one processor configured to provide a plurality of closed-access network micro-communities associated with a corresponding plurality of institutions. Each micro-community and corresponding institution may have an associated access list. The processor may display on user devices a user interface portal which is confined to the selected micro-community. The processor may receive via the user interface portal user data from the member users, which is instantly visible in the user interface portal to all member users. The processor may also receive via the user interface portal institution data from one or more administrators of the institution associated with the selected micro-community, which is also instantly visible in the user interface portal to all member users. The processor thus provides a secured-access open exchange between the member users and a secured-access feed from the institution to the member users.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example of a system for providing closed-access network micro-communities.

FIGS. 2-17 show screen-shots of an example implementation of a system of closed-access network micro-communities.

FIG. 18 depicts multiple inter-related “wire-frame” screens of a system of closed-access network micro-communities.

### DETAILED DESCRIPTION

An example of a system according to the present disclosure involves a closed-access platform, or network of closed-access micro-communities, that securely connects users through their ties to an institution. Although not limited, an institution may be an organization, establishment, foundation, society, or the like (e.g., high schools, universities, etc.), devoted to the promotion of a particular cause or program, especially one of a public, educational, or charitable character.

In the system users are part of exclusive controlled-access groups, or micro-communities. The micro-communities are isolated from one another such that member users in one micro-community are invisible to member users of other micro-communities. The micro-community environment thus provides a sort of “safe-haven” for interactions and communications among member users that are connected by their association with the institution and interactions and communications between the institution and those associated member users. The user in a particular micro-community may include the institution, such as administrators of the institution, employees of the institution, and users that are associated with the institution. For an educational institution these may be school administrators, current students of the school, parents of students, alumni of the school, and various other members associated with the particular school. Typically these users will share a similar set of beliefs and values through their association with the common institution. However, prior to the system disclosed herein, there has been a challenge in uniting such users under a common platform in a secure environment that is isolated from other users that are not associated with the given institution. The system, by uniting the institution and associated users in a secure micro-community, may thus provide the ability to more readily communicate among users associated with an institution and the ability for the institution to more readily communicate with its associated users, both of which in turn create value for the institution and users.

As an example, an institution can create an exclusive micro-community in the system, which may be one of many micro-communities among many institutions, and invite new users that are involved with the institution to join the micro-community Examples of institutions may include, but are not limited to, high schools, colleges/universities, and private organizations, such as The Boy Scouts of America, charities, and religious parishes. After an institution registers an account in the system, the institution and their associated member users will receive access to one another and various resources through a user interface portal of the micro-community. The member users and institution can then interact and communicate in the micro-community via the user interface portal, which provides a secure, isolated virtual environment just for those users.

Through the use of the system an institution may increase exposure to its member users and increase revenue through the user interface portal. As an example, member users may post their business, such as advertisements, to the micro-community by paying a fee. In some examples, the fee may be handled or received by the proprietor of the system and then passed to the institution, and the proprietor and the institution may divide the fee.

Additionally, an institution may increase donations. For instance, the user interface portal displays a donation section which may link directly to the institution website page to make a donation to the institution. This provides member users the opportunity to easily donate to their associated institution, whereas it is often otherwise difficult for an institution to connect with its associated people and solicit and collect donations. The system additionally permits an institution to directly access its associated member users, such as students, parents of students, and alumni, with news feeds, events, or other posts that are instantaneously visible to the member users in the user interface portal. Communication from institution to member user is thus efficient and effective.

Each member user has a personal profile in the user interface portal, which may display the member user's name and photo along with other information, such as a short biography, education, work experience, and skills. Through the user interface portal, which may be accessed on a user device (e.g., a computer, tablet, or cellular device) via a website, app, or the like, member users can access and view a homepage. In the examples that follow, this homepage may be referred to as “The Quad.” The homepage may display various feeds to the member users, which will be explained further in the examples that follow. The feeds, for example, may be posts from the institution or posts from other member users. Posts from the institution and from the member users are instantly visible to all member users in the given micro-community. In addition, the system may provide the member users with feeds related to employment opportunities, employment-seeking, businesses, benefits, and social events that are posted by member users and the institution.

The system may also provide a mentoring feature through the user interface portal. When member users create their profiles they are given the option to indicate that they are willing to mentor other member users. This feature provides member users, such as students, the opportunity to receive advice or guidance from established member users, such as alumni within their institution.

The system may also be adapted for member users of various age levels, of different relations to the institution, or of other identified classifications. The following illustrate a few examples.

High School Students

Post updates/information regarding various clubs and sports teams.

Follow news and updates taking place at the institution.

Communicate and promote student-led events taking place at the institution.

Keeping in contact and communicating with coaches and teammates.

Access to classmates and the opportunity to assist one another with schoolwork and the creation of study groups (e.g., sharing notes, tutoring, homework help, etc.).

Access to alumni and the opportunity to be mentored and receive advice, specifically information to assist with college selection.

Opportunity to find jobs/summer jobs, specifically from parents within the group (e.g., babysitting jobs, landscaping jobs, house work, etc.).

Opportunity for students to offer their time to volunteer for community service hours.

College Students

Post updates/information regarding various clubs, intermural sports, activities, promotions, speakers, events, etc. taking place at the university.

Follow news and updates taking place at the university.

Promote themselves or a club/activity they have an affiliation with.

Access to alumni and the opportunity to be mentored and receive advice, specifically with career advice.

The opportunity to connect with classmates.

The opportunity to sell books, furniture, apartments, tutoring services, sports games tickets, etc. to other students.

Parents of Students

Follow news and updates taking place at the school.

The opportunity to connect with other parents at the school.

The opportunity to post their businesses to the group ultimately leading to increased business and exposure.

The opportunity to post advertisements for their businesses to the group, ultimately leading to increased exposure.

The opportunity to post promotions/coupons for their businesses to the group.

The opportunity to post job listings and find new employees from their micro-community.

Access to various job opportunities posted within the micro-community.

Access to alumni and the opportunity to be mentored and receive advice specifically with career advice.

The opportunity to expand and grow professional network of connections.

Alumni

The opportunity to post their businesses to the group ultimately leading to increased business and exposure.

The opportunity to post advertisements for their businesses to the group, ultimately leading to increased exposure.

The opportunity to post promotions/coupons for their businesses.

The opportunity to post job listings and find new employees.

Access to various job opportunities.

Access to alumni and the opportunity to be mentored and receive advice specifically with career advice.

The opportunity to expand and grow their professional network of connections.

An avenue to connect with old friends and classmates.

Institution Faculty/Staff

A way to share announcements and updates with their students in their specific classes.

A simple way to teach and provide assistance to students outside of the classroom setting.

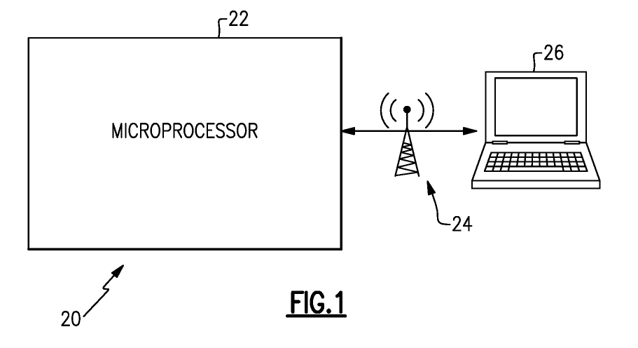

FIG. 1 shows an example system 20. The system 20 includes at least one processor 22. For instance, the processor 22 is part of a computer, a server, or the like. The processor 22 may include hardware, software, or both that is programmed or configured according to the present disclosure. Users of the system 20 may be in communication with the processor 22 via a communication channel or channels 24, such as a wired or wireless network. The processor 22 may be configured to send and receive data over the communication channel 24 with respect to user devices 26. The user devices may be, but are not limited to, computers, tablets, and cellular devices. The processor 22 may be configured to display on the user devices 26 a user interface portal. The user interface portal may be, but is not limited to, a website that is accessible from the user devices 26 or software (e.g., a mobile app) that is on the user devices 26 or accessible by the user devices 26.

The system 20 is configured to:
provide a plurality of closed-access network micro-communities associated with a corresponding plurality of institutions, each micro-community and corresponding institution having an associated access list,
prompt new users to enter user information and associate new users with a selected one of the micro-communities as member users of that selected micro-community if the user information is deemed to match the access list of the selected micro-community,
display on user devices of the member users a user interface portal, the user interface portal being confined to the selected micro-community such that other ones of the micro-communities for which the member users are not associated with are invisible to or inaccessible by the member users of the selected micro-community in the user interface portal,
receive via the user interface portal posts of user data from the member users in the selected micro-community, the posts of user data being instantly visible in the user interface portal to all member users of the selected micro-community, thereby providing a secured-access open exchange between the member users, and
receive via the user interface portal posts of institution data from one or more administrators of the institution associated with the selected micro-community, the posts of institution data being is instantly visible in the user interface portal to all member users of the selected micro-community, thereby providing a secured-access feed from the institution to the member users.

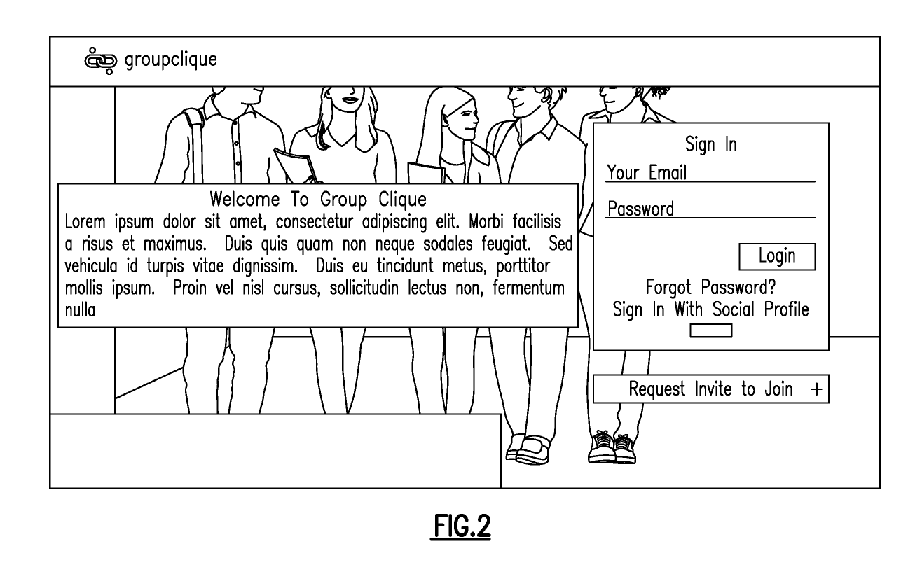

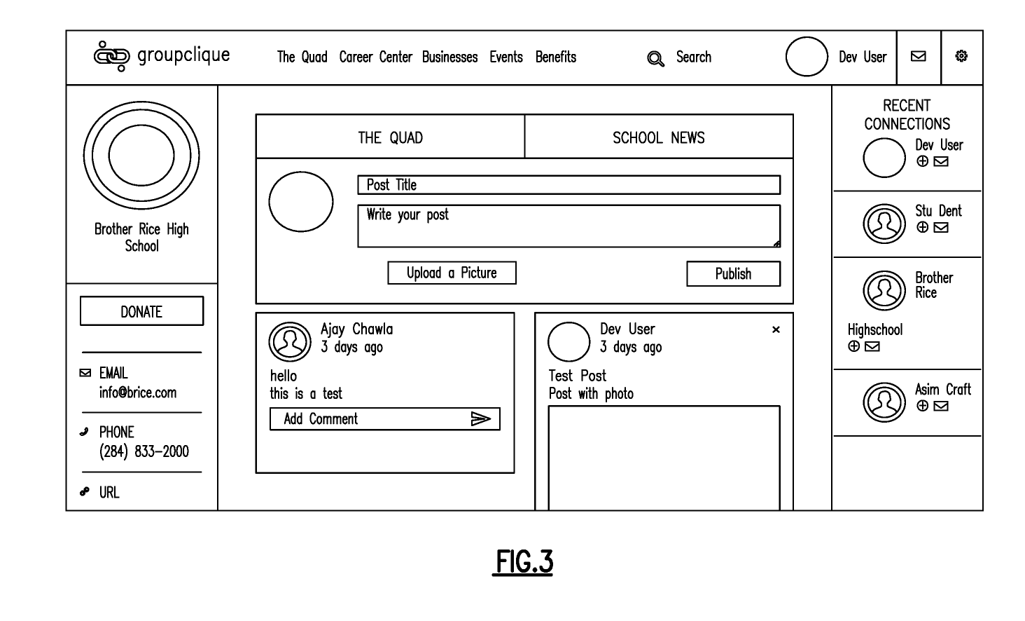

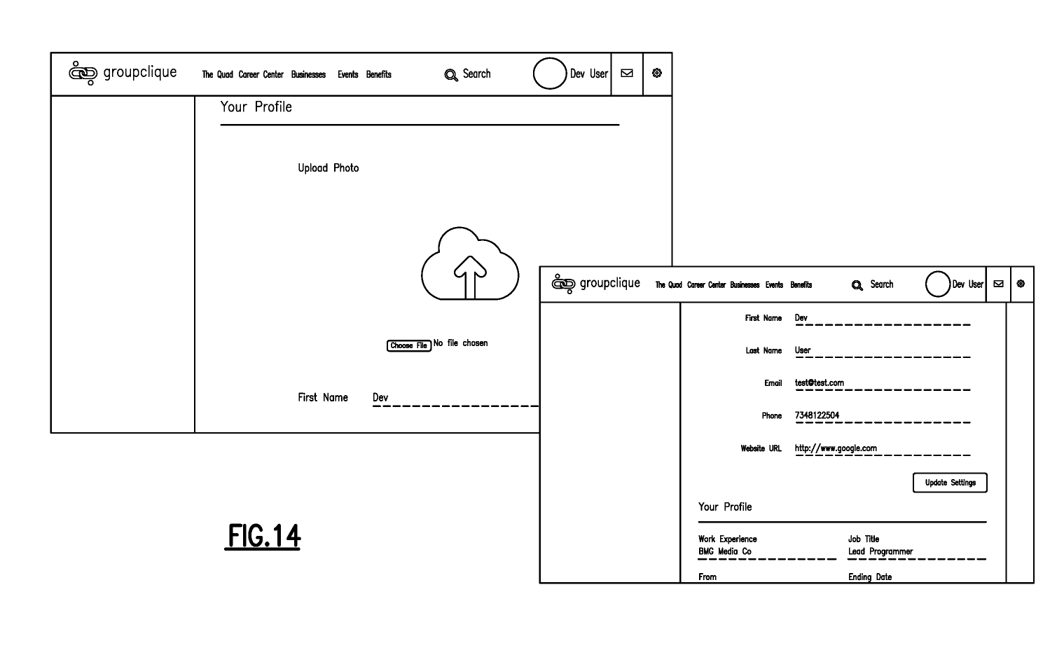

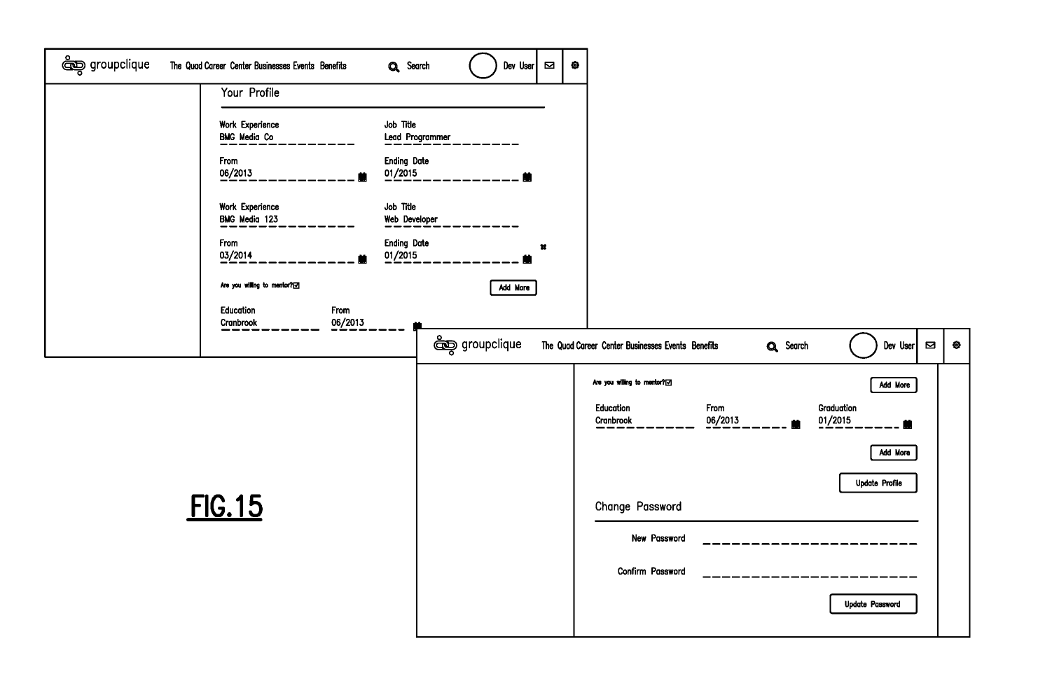

FIGS. 2 through 17 show screen-shots of a user interface portal from an example implementation of the system 20, although it is to be appreciated that the system 20 also embodies a method related thereto. FIG. 2 shows a homepage or login page that new users first encounter when they access the user interface portal. As an example, if the institution with which the new user is associated is not yet registered in the system, the new user is given the option to request an invite to join the institution. The user interface portal provides for the new user to enter user information, such as the new user's name, name of the selected institution with which they are associated, and user contact information. This information may be used to validate the new user against an access list of the selected institution. The new user may then be accepted as a member user of the selected micro-community associated with the selected institution if the user information is deemed to match the access list of the selected micro-community and institution. Such matching may be conducted manually or by computer.

Upon logging in to the system 20 through the user interface portal, member users of the selected micro-community are taken to an initial user page. On the initial user page the user interface portal provides several sections for different feeds of information related to the micro-community. A first section, which in this implementation is referred to as “The Quad,” displays a member user message feed of all messages from the member users of the micro-community. The messages are a part of user data, which is any information received into the user interface portal from member users. The posts of user data are instantly visible in the user interface portal to all member users of the selected micro-community, thereby providing a secured-access open exchange between the member users. As an example, all posts from all member users may be displayed in the first section, and each member user is able to create posts or comment on posts of other member users.

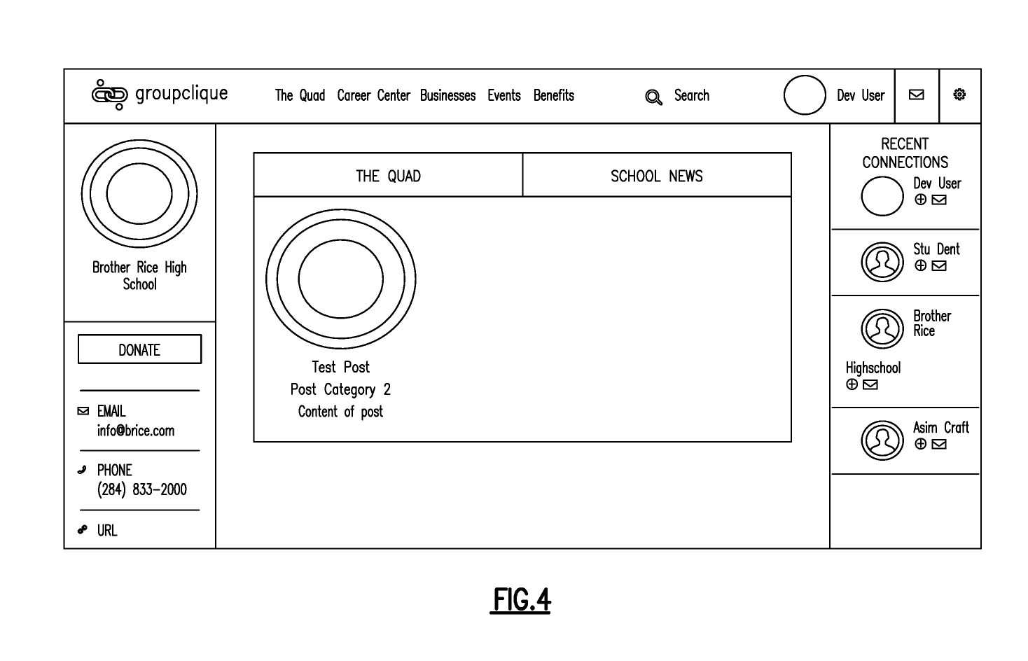

As also shown in FIG. 4, the initial user page also includes a second section, which in this implementation is referred to as “School News.” The second section displays posts of institution data received from one or more administrators of the institution associated with the selected micro-community. The posts are a part of institution data, which is any information received into the user interface portal from the administrators of the institution. The posts of institution data are instantly visible in the user interface portal to all member users of the selected micro-community, thereby providing a secured-access feed from the institution to the member users. As an example, the second section may display all posts of the institution data. Such posts may include, for example only, institution news, announcements, updates, and accomplishments for all member users to view.

In this example, the user interface portal also provides permits member users to easily donate to the institution using a prominent link. The link may lead to a website of the institution for making such donations or may lead to a page in the user interface portal that is configured to receive donation information, such as monetary amounts and credit card information.

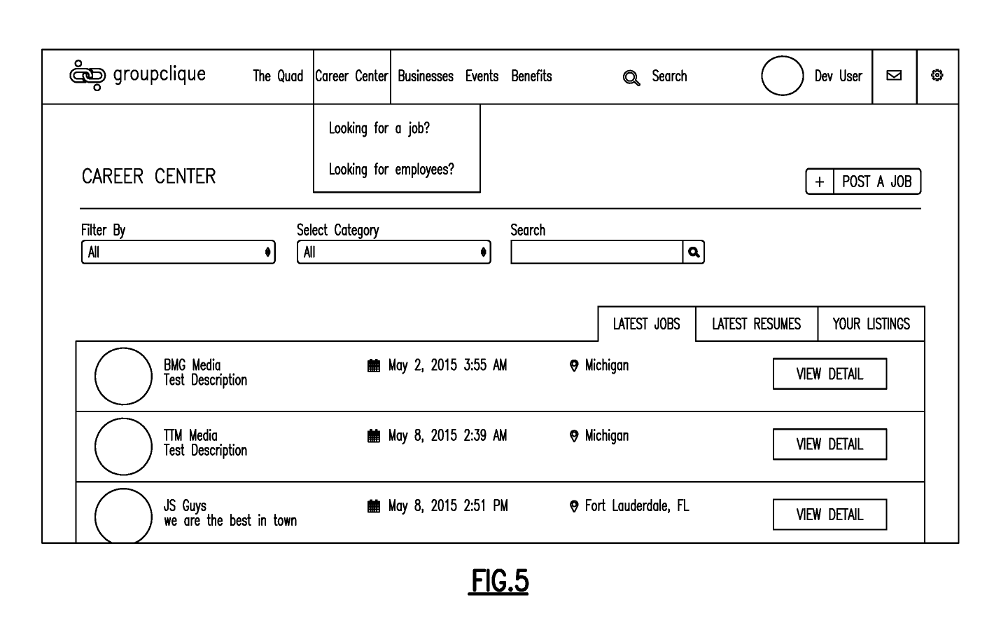

As shown in FIG. 5 the user interface portal also includes an employment section, which in this implementation is referred to as “Career Center.” The employment section displays a member user employment feed of all employment opportunities posted by member users. This page also permits member users to enter new employment opportunities to the member user employment feed, thereby providing a secured-access employment opportunity exchange between the member users. As an example, member users can search in this section for job opportunities or seek new employees from their own business. The posted employment opportunities may be listed chronologically, but the user interface portal also provides a filter that is operative by the member users to sort the employment opportunities according to a selected characteristics. For example, member users can filter jobs by function or by a selected industry or category. The user interface portal may also provide a user-search that is operative by the member users to search the employment opportunities according to a user-entered word.

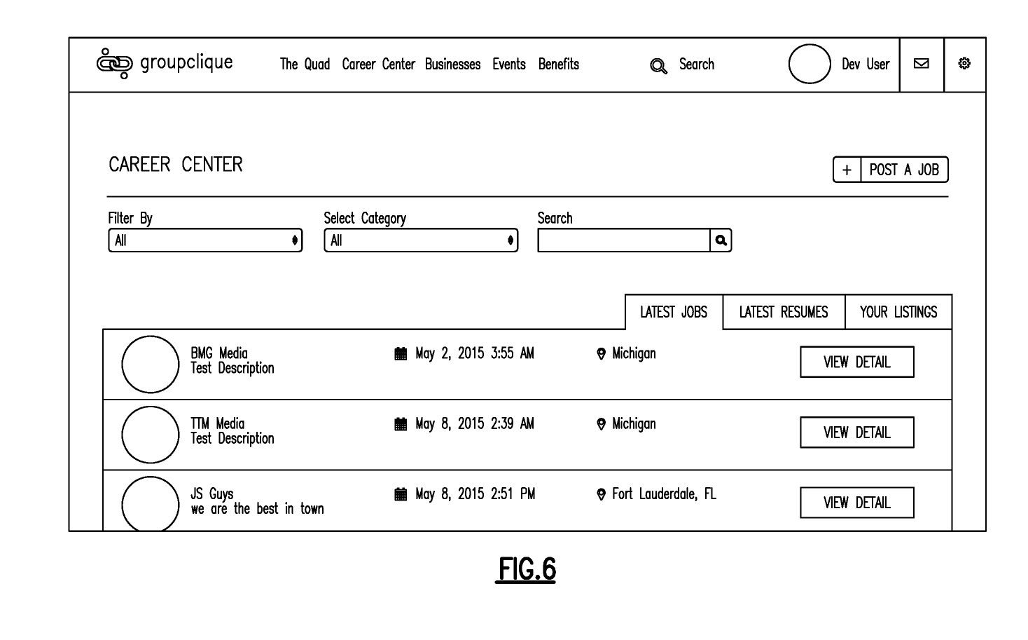

As shown in FIG. 6, the employment section also provides, for each one of the member users, a display of a member user listing feed of employment opportunities which the member user posted or flagged in the user interface portal. For example, this section permits a member user to view the employment opportunities that they have posted or employment opportunities that they have applied for or flagged is being interested in.

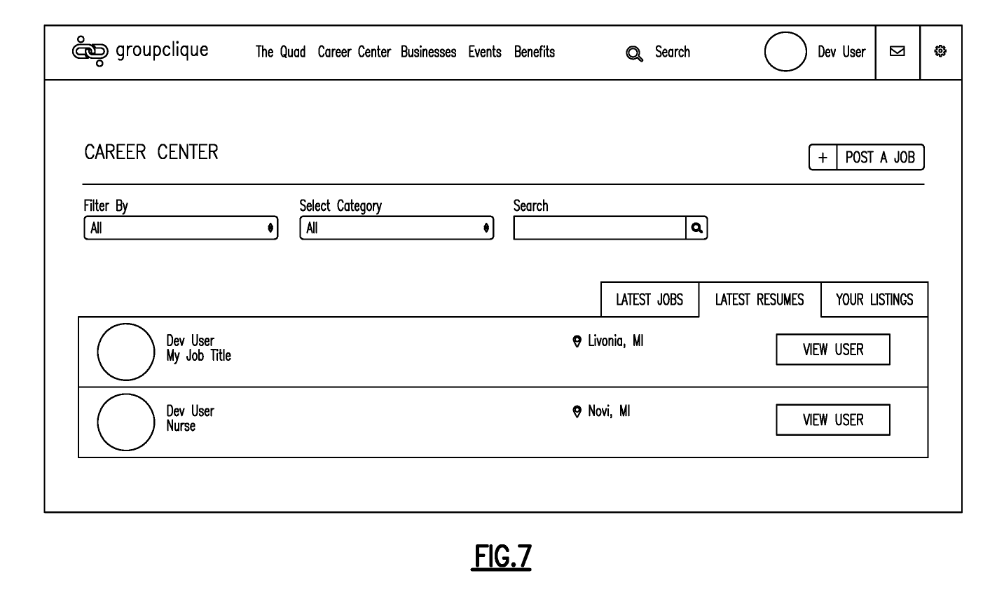

As shown in FIG. 7, the employment section may further display a member user resume feed of all resumes posted by member users. The user interface portal may also permit member users to enter new resumes to the member user resume feed, thereby providing a secured-access resume exchange between the member users. Resumes may be displayed chronologically in the feed.

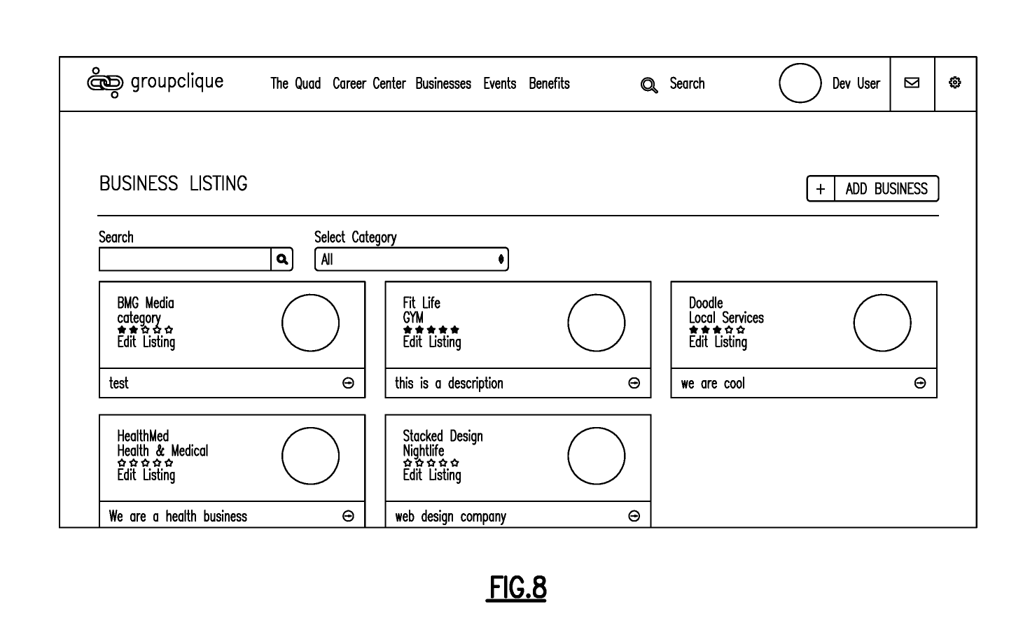

In FIG. 8, the user interface portal includes a business section that displays a member user advertisement feed of all advertisements posted by member users. The portal also permits member users to enter new advertisements to the member user advertisement feed, thereby providing a secured-access advertisement exchange between the member users. Such advertisements may be a business listing of the member user or a commercial advertisement, logo, etc. Additionally, the user interface portal may provide a user-search that is operative by the member users to search the advertisements according to a user-entered word or selected category. As an example, a proprietor of the system 20 or the institution associated with the selected micro-community may implement a payment structure that enables member users to post advertisements for view by all member users only if paying the fee. The fee may be divided between the proprietor and the institution. Member users can easily search for advertisements, such as business listings, by name or browse through businesses within a selected industry or category.

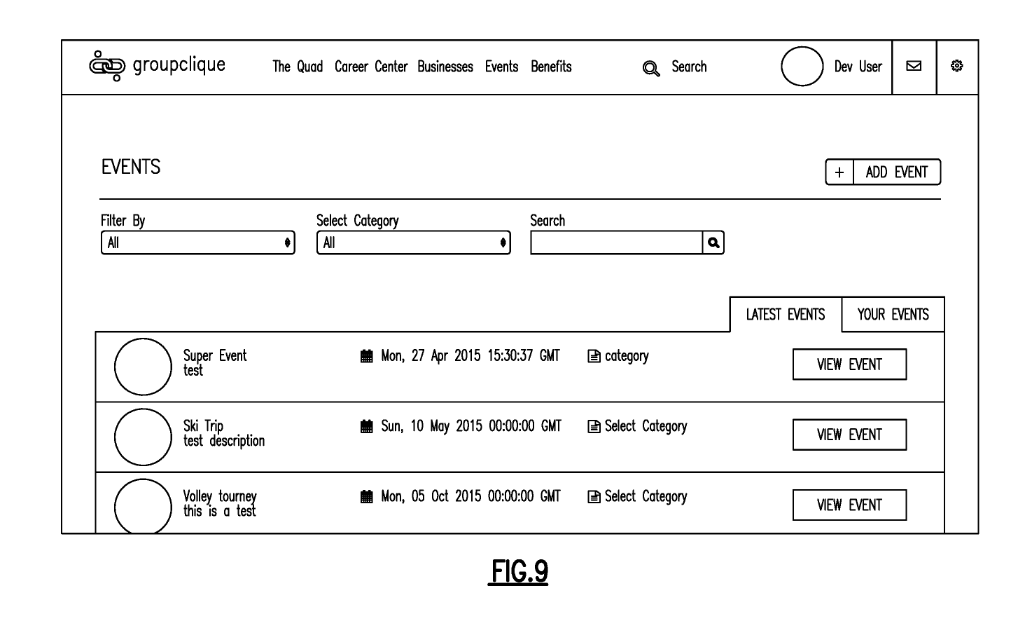

In FIG. 9 the user interface portal includes a social events section that displays a member user social event feed of all social events posted by member users. The portal may also permit member users to enter new social events to the member user social event feed, thereby providing a secured-access social events exchange between the member users. The user interface portal may provide a user-search that is operative by the member users to search the social events according to a user-entered word or selected category. The social events may be listed chronologically in the feed, but member users can easily search by name or browse through events within a selected category.

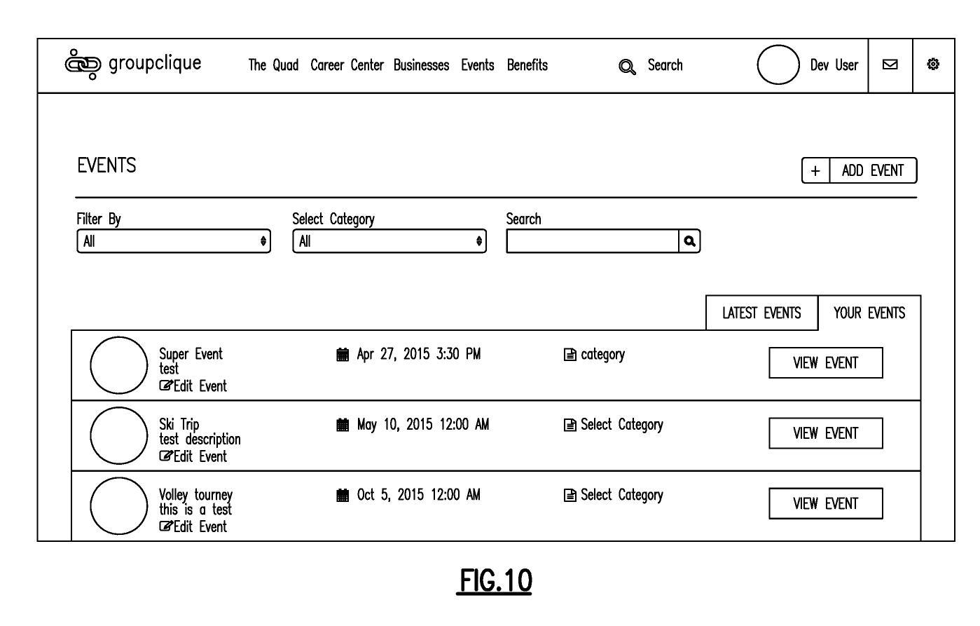

As shown in FIG. 10, the social events section may also provide, for each one of the member users, a display of a member user social events listing feed of the social events that the member user has posted or flagged in the user interface portal.

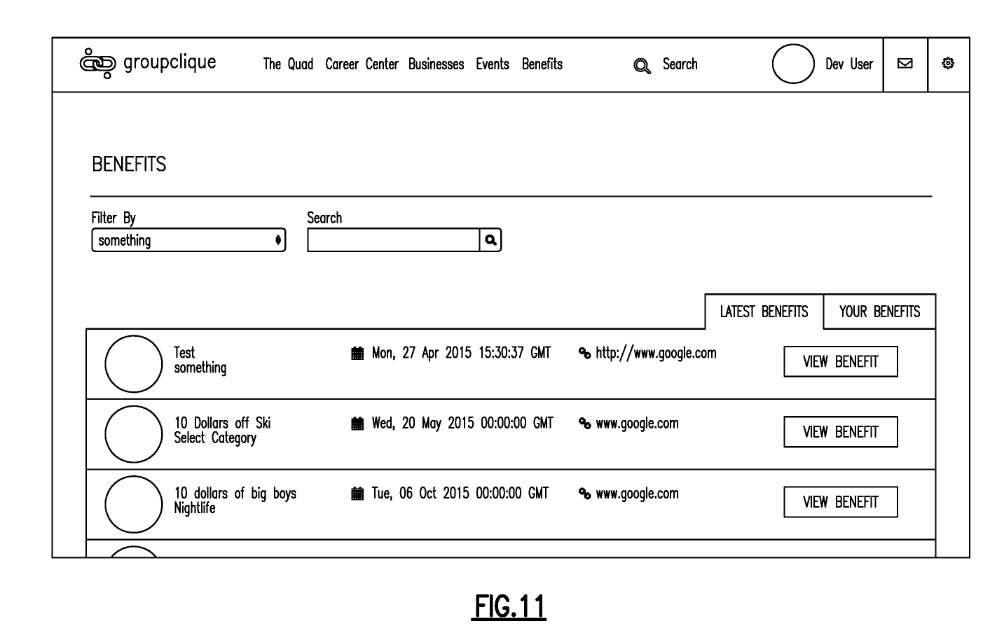

In FIG. 11, the user interface portal includes a benefits section that displays a member user benefits feed of all benefits posted by member users. The portal also permits member users to enter new benefits to the member user social event feed. As an example, the benefits may include at least one of coupons, promotions, and discounts, thereby providing a secured-access benefits exchange between the member users. As an example, the benefits may be listed in chronological order in the feed but member users can easily search for benefits by name or browse through benefits within a selected business category.

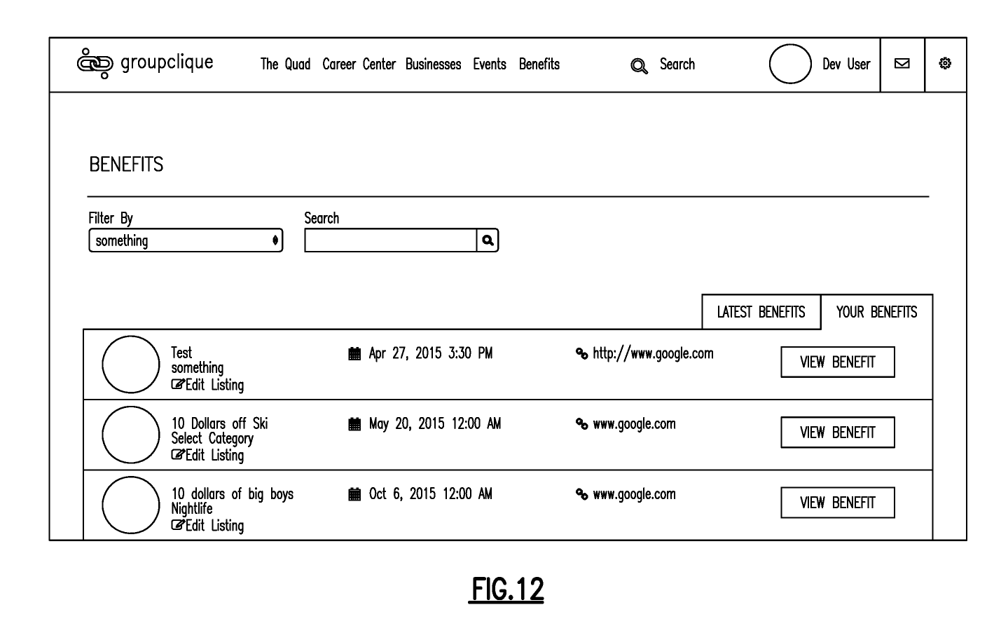

As further shown in FIG. 12, the benefits section may also provide, for each one of the member users, a display of a member user benefits listing feed of benefits that the member user posted or flagged in the user interface portal.

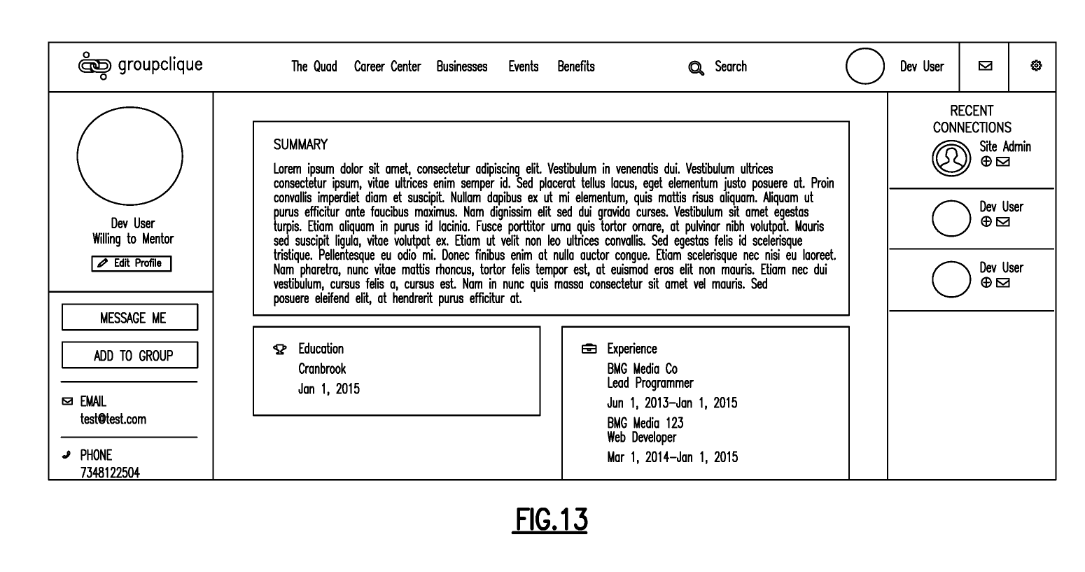

As depicted in FIGS. 13-15, the user interface portal may further include a user profile section that displays a plurality of fields of user profile information. The user profile section also permits member users to enter or change the user profile information. As an example, the user profile section is a custom page for each member user. It may display a biography about the member user, their past education, their work history, their skills, and the like. Also listed on the user profile are events, business listings, and employment listings that the user has recently visited or posted. The user profile section may also list (on the right-hand side in FIG. 13) a stream of recently added member users that have joined the micro-community. The portal may provide the member users an option to direct message the recently added member users or to add them to smaller, customizable sub-communities within the micro-community.

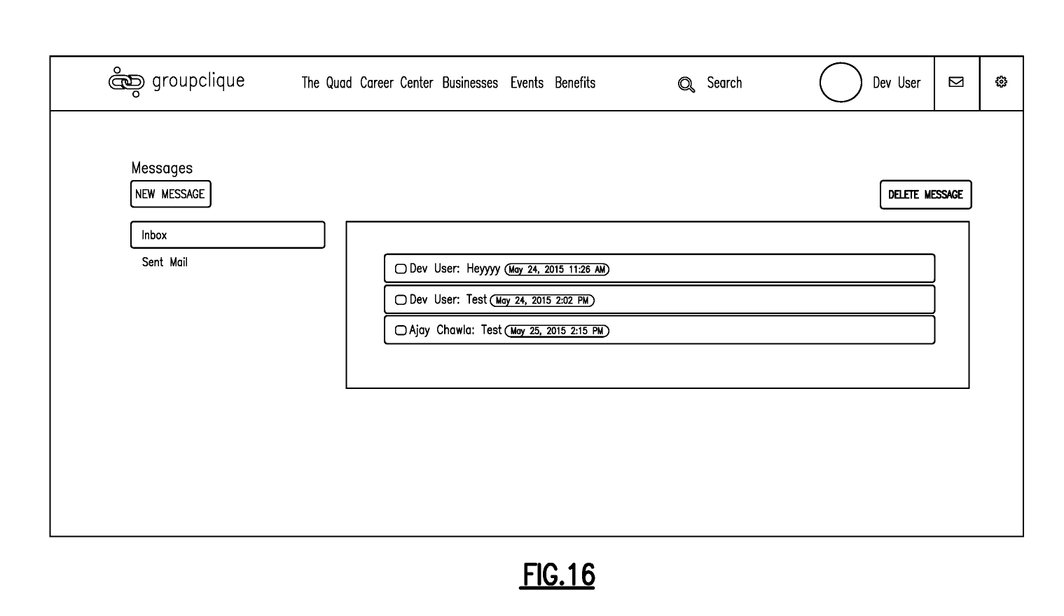

As shown in FIG. 16, the user interface portal may additionally include a direct messaging section that permits member users to send and receive messages with selected other member users via the user interface portal.

In all of the aforementioned examples, the system 20 may also provide notifications to the member users. Such notifications may be email notifications, text notifications, mobile application badge notifications, mobile device banner notifications, and the like. The notifications may be to notify the member user that a message has been received in the system 20, that there is a responsive post to something the member user posted, reminder of events, notifications concerning events that the member user has flagged or signed up for, posts from the institution, etc. The user interface portal may also provide the ability for member users to activate and deactivate notifications and control the type of notifications. For instance, this capability may be provided as a preference in the user profile section or elsewhere.

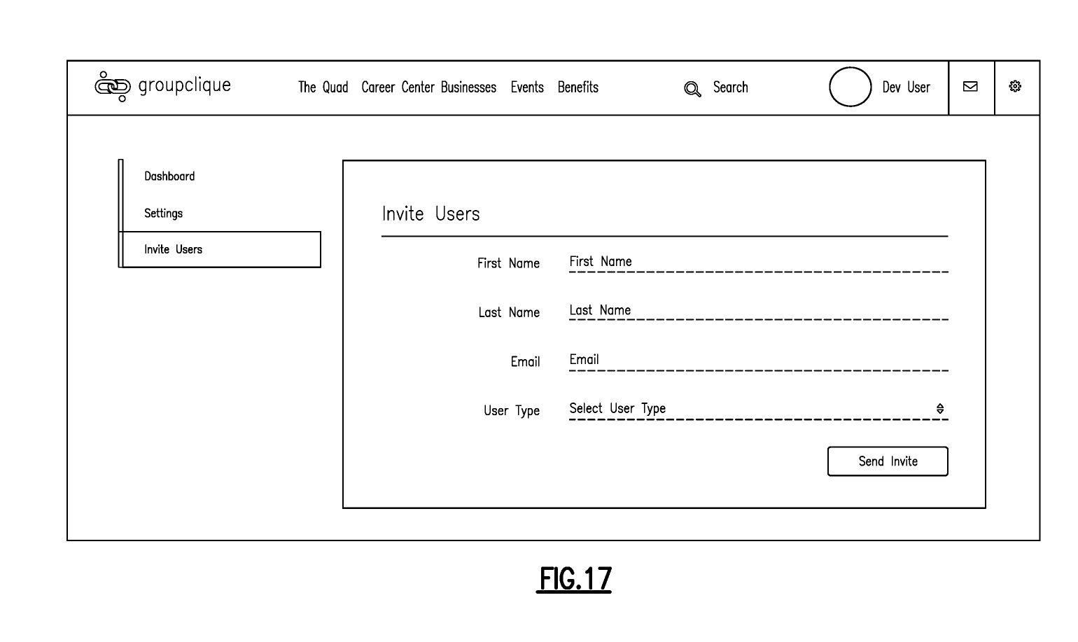

In FIG. 17, the user interface portal includes an invitation section that permits member users to invite additional new users to join the selected micro-community as member users of the selected micro-community. For example, the new users may be added as member users if user information of the additional new users is deemed to match the access list of the selected micro-community. Additionally or alternatively, the portal may only permit member users to invite new users that have an association with the selected institution associated with the selected micro-community. For example, those may be students, parents, or alumni

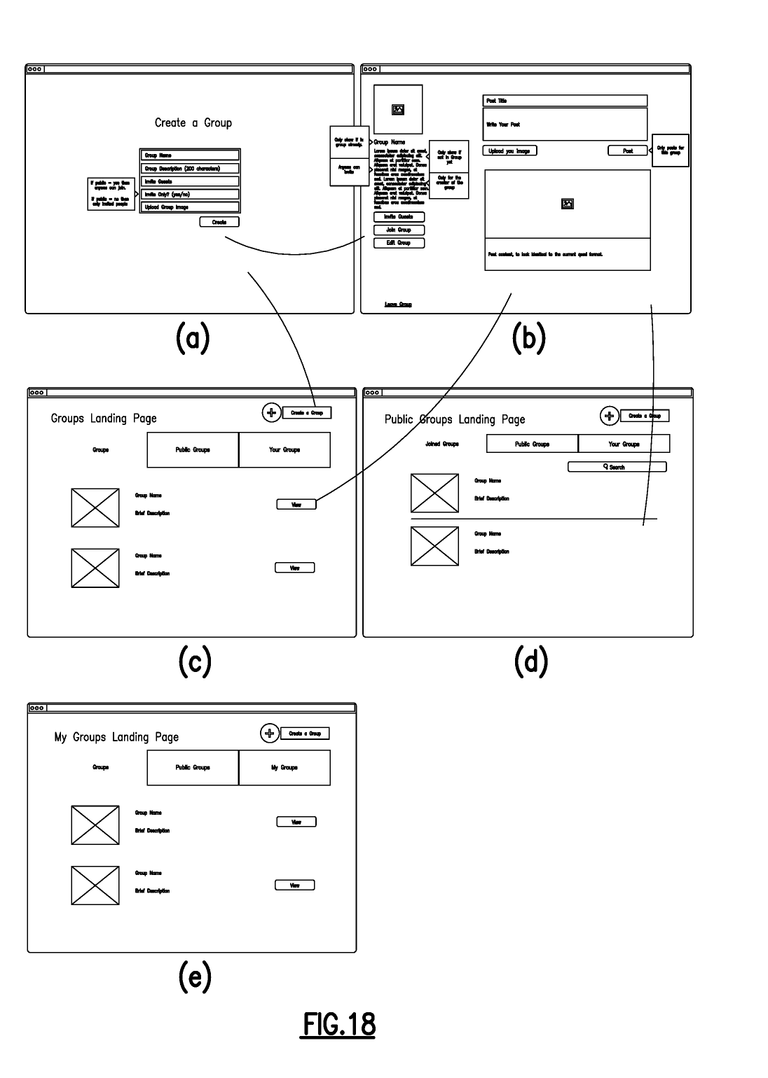

FIG. 18 depicts multiple inter-related “wire-frame” screens of the system 20. For example, wireframe (a) is directed to creating a sub-group in the micro-community and is linked with wire-frame (b) and (c). Wire frame (b) is directed to entry of details for creating a sub-group and wire-frame (c) is directed to design of an initial landing page, i.e., an initial user page. In this example, the landing page may also display to member users information of public communities or groups that any user across multiple micro-communities in the system 20 may join. Wire-frame (d) is directed to a public community or group landing page which may display a list of public communities available to join. Finally, screen (e) is a database table of information, such as user information and institution information that may be collected in connection with the micro-communities and public communities.

Through the user interface portal as represented in wireframe (a) a member user is permitted to invite other member users in the same micro-community to join a sub-group in the micro-community that is created by that member user. For instance, the user interface portal only permits the creator of the sub-group to invite member users that are in the same micro-community. As examples, the sub-groups may be related to clubs, alumni, athletic teams, etc. The member users of the sub-group can then easily communicate in the micro-community among only each other by posting or sending messages that are viewed only by the sub-group. Documents or other types of computer files may also be sent or shared among a sub-group, to individual member users, or to the micro-community. Such documents may be sent or shared by a member user or by the institution.

One or more administrators of the institution may also be given administrative authority in the system 20. As examples, such administrative authority may include the abilities to suspend access of member users of the selected micro-community, terminate/delete member users of the selected micro-community, and add new users as member users to the selected micro-community.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A system comprising:
at least one processor configured to:
provide a plurality of closed-access network micro-communities associated with a corresponding plurality of institutions, each micro-community and corresponding institution having an associated access list,
prompt new users to enter user information and associate new users with a selected one of the micro-communities as member users of that selected micro-community if the user information is deemed to match the access list of the selected micro-community,
display on user devices of the member users a user interface portal, the user interface portal being confined to the selected micro-community such that other ones of the micro-communities for which the member users are not associated with are invisible to or inaccessible by the member users of the selected micro-community in the user interface portal,
receive via the user interface portal posts of user data from the member users in the selected micro-community, the posts of user data being instantly visible in the user interface portal to all member users of the selected micro-community, thereby providing a secured-access open exchange between the member users, and
receive via the user interface portal posts of institution data from one or more administrators of the institution associated with the selected micro-community, the posts of institution data being is instantly visible in the user interface portal to all member users of the selected micro-community, thereby providing a secured-access feed from the institution to the member users.

2. The system as recited in claim 1, wherein the user interface portal includes a first section displaying a member user message feed of all messages of the user data from the member users and a second section displaying an institution message feed of all messages of the institution data from the one or more administrators.

3. The system as recited in claim 1, wherein the user interface portal includes an employment section displaying a member user employment feed of all employment opportunities of the user data posted by member users and permitting member users to enter new employment opportunities to the member user employment feed, thereby providing a secured-access employment opportunity exchange between the member users.

4. The system as recited in claim 3, wherein the user interface portal provides a filter that is operative by the member users to sort the employment opportunities of the user data according to a selected characteristic.

5. The system as recited in claim 3, wherein the user interface portal provides a user-search that is operative by the member users to search the employment opportunities of the user data according to a user-entered word.

6. The system as recited in claim 3, wherein the employment section provides, for each one of the member users, a display of a member user listing feed of ones of the employment opportunities which each member user posted or flagged in the user interface portal.

7. The system as recited in claim 1, wherein the user interface portal includes an employment section displaying a member user resume feed of all resumes of the user data posted by member users and permitting member users to enter new resumes to the member user resume feed, thereby providing a secured-access resume exchange between the member users.

8. The system as recited in claim 1, wherein the user interface portal includes a business section displaying a member user advertisement feed of all advertisements of the user data posted by member users and permitting member users to enter new advertisements to the member user advertisement feed, thereby providing a secured-access advertisement exchange between the member users.

9. The system as recited in claim 8, wherein the user interface portal provides a user-search that is operative by the member users to search the advertisements according to a user-entered word or selected category.

10. The system as recited in claim 1, wherein the user interface portal includes a social events section displaying a member user social event feed of all social events of the user data posted by member users and permitting member users to enter new social events to the member user social event feed, thereby providing a secured-access social events exchange between the member users.

11. The system as recited in claim 10, wherein the user interface portal provides a user-search that is operative by the member users to search the social events according to a user-entered word or selected category.

12. The system as recited in claim 10, wherein the social events section provides, for each one of the member users, a display of a member user social events listing feed of ones of the social events which each member user posted or flagged in the user interface portal.

13. The system as recited in claim 1, wherein the user interface portal includes a benefits section displaying a member user benefits feed of all benefits of the user data posted by member users and permitting member users to enter new benefits to the member user social event feed, the benefits including at least one of coupons, promotions, and discounts, thereby providing a secured-access benefits exchange between the member users.

14. The system as recited in claim 13, wherein the benefits section provides, for each one of the member users, a display of a member user benefits listing feed of ones of the benefits which each member user posted or flagged in the user interface portal.

15. The system as recited in claim 1, wherein the user interface portal includes a user profile section displaying a plurality of fields of user profile information and permitting member users to enter the user profile information.

16. The system as recited in claim 1, wherein the user interface portal includes a direct messaging section permitting member users to send and receive messages with selected other member users via the user interface portal.

17. The system as recited in claim 1, wherein the user interface portal includes an invitation section permitting member users to invite other member users of the selected micro-community to join a sub-group in the selected micro-community.

18. The system as recited in claim 1, wherein the user interface portal includes donation section which permits member users to monetarily donate to the institution associated with the selected micro-community.

19. A method comprising:
providing a plurality of closed-access network micro-communities associated with a corresponding plurality of institutions, each micro-community and corresponding institution having an associated access list,
prompting new users to enter user information and associating new users with a selected one of the micro-communities as member users of that selected micro-community if the user information is deemed to match the access list of the selected micro-community,
displaying on user devices of the member users a user interface portal, the user interface portal being confined to the selected micro-community such that other ones of the micro-communities for which the member users are not associated with are invisible to or inaccessible by the member users of the selected micro-community in the user interface portal,
receiving via the user interface portal posts of user data from the member users in the selected micro-community, and instantly displaying the posts of user data in the user interface portal to all member users of the selected micro-community, thereby providing a secured-access open exchange between the member users, and
receiving via the user interface portal posts of institution data from one or more administrators of the institution associated with the selected micro-community, and instantly displaying the posts of institution data in the user interface portal to all member users of the selected micro-community, thereby providing a secured-access feed from the institution to the member users.
